(19) United States
(12) Patent Application Publication
(10) Pub. No.: US 2025/0377207 A1
(43) Pub. Date: Dec. 11, 2025

(54) METHOD, DEVICE, AND RECORDING MEDIUM FOR LOCALIZING AUTONOMOUS VEHICLE BY FUSING PLURALITY OF LOCALIZATION TECHNOLOGIES

(71) Applicant: RideFlux Inc., Jeju-si (KR)

(72) Inventors: Ho YUN, Jeju-si (KR); Jung Hee PARK, Jeju-si (KR); Deokhwa HAN, Jeju-si Jeju-do (KR); Jiwoong KIM, Seoul (KR); Gwanguk JUNG, Jeju-si Jeju-do (KR); Donghee HAN, Anyang-si (KR)

(73) Assignee: RideFlux Inc., Jeju-si (KR)

(21) Appl. No.: 19/206,981

(22) Filed: May 13, 2025

Related U.S. Application Data
(63) Continuation of application No. PCT/KR2022/019883, filed on Dec. 8, 2022.

(30) Foreign Application Priority Data
Dec. 2, 2022 (KR) 10-2022-0166380

(51) Int. Cl. G01C 21/30; B60W 60/00

(52) U.S. Cl. CPC G01C 21/30; B60W 60/001; B60W 2556/35; B60W 2556/40

(57) ABSTRACT

A method, device, and recording medium for localizing an autonomous vehicle by fusing a plurality of localization technologies are provided. The method for localizing an autonomous vehicle by fusing a plurality of localization technologies according to various embodiments of the present invention is a method for localizing an autonomous vehicle by fusing a plurality of localization technologies, which is performed by a computing device, and includes an operation of calculating a plurality of localization values by performing localization for a vehicle located in a predetermined region using a plurality of localization technologies for performing localization according to different localization methods; and determining a position and orientation of the vehicle by fusing the plurality of calculated localization values as a result of localizing the vehicle.

### CROSS REFERENCE TO RELATED APPLICATIONS

The present application is a continuation of International Patent Application No. PCT/KR2022/019883, filed on Jun. 6, 2024, which is based upon and claims the benefit of priority to Korean Patent Application No. 10-2022-0166380, filed Dec. 2, 2022, the entire contents of which are incorporated herein for all purposes by this reference.

### TECHNICAL FIELD

Various embodiments of the present invention relate to a method, device, and recording medium for localizing an autonomous vehicle by fusing a plurality of localization technologies.

### BACKGROUND ART

For the convenience of users who drive vehicles, various sensors and electronic devices (for example, an advanced driver assistance system (ADAS)) are being installed, and in particular, technology development for an autonomous driving system for a vehicle that recognizes a surrounding environment without driver intervention and automatically drives to a given destination according to the recognized surrounding environment is actively underway.

Here, an autonomous vehicle is a vehicle having an autonomous driving system function for recognizing a surrounding environment without driver intervention and automatically driving to a given destination according to the recognized surrounding environment.

An autonomous driving system performs localization, recognition, prediction, planning, and control for autonomous driving.

Here, the localization is an autonomous driving element technology, and refers to an operation of recognizing an exact position and orientation of an autonomous vehicle, and the autonomous driving system performs the localization for the autonomous vehicle using a map of an area where the autonomous vehicle will drive.

Examples of a representative localization technology for performing the localization for the autonomous vehicle include a localization technology for measuring a position of an autonomous vehicle using a global navigation satellite system (GNSS), a localization technology for measuring acceleration and rotational speed information of an autonomous vehicle using an inertial measurement unit (IMU) and estimating a moving distance and direction (orientation) of the autonomous vehicle based on the information, and a localization technology for measuring a position and orientation of an autonomous vehicle by comparing sensor information collected using sensors such as cameras or lidars with previously stored precision map information.

Meanwhile, high-precision localization technology is required in order to perform full autonomous driving for an autonomous vehicle, but in the case of the localization technologies as described above, there is a problem that localization reliability is degraded because localization performance is degraded in some sections depending on regional characteristics. For example, there is a problem that the performance of GNSS- based localization technology is degraded in a forest tunnel or a forest of buildings, and there is a problem that the performance of NDT-based localization technology is degraded in a road environment with few landmarks.

### DISCLOSURE

### Technical Problem

The present invention is directed to providing a method, device, and recording medium for localizing an autonomous vehicle by fusing a plurality of localization technologies, which are capable of deriving more precise localization results by fusing a plurality of localization values calculated through the plurality of localization technologies to determine a position and orientation of an autonomous vehicle, for the purpose of solving the above-described conventional problems.

The present invention is also directed to providing a method, device, and recording medium for localizing an autonomous vehicle by fusing a plurality of localization technologies, which are capable of performing more precise and accurate localization in consideration of regional characteristics of a region in which an autonomous vehicle is located, by fusing a plurality of localization technologies for performing localization according to different localization methods to determine a position and orientation of the vehicle and assigning a localization technology-specific weight in consideration of the regional characteristics.

The objects of the present invention are not limited to the objects mentioned above, and other objects that are not mentioned can be clearly understood by those skilled in the art from the description below.

### Technical Solution

A method for localizing an autonomous vehicle by fusing a plurality of localization technologies according to an aspect of the present invention for solving the above-described problem is a method for localizing an autonomous vehicle by fusing a plurality of localization technologies, which is performed by a computing device, the method including: calculating a plurality of localization values by performing localization for a vehicle located in a predetermined region using a plurality of localization technologies for performing localization according to different localization methods; and determining a position and orientation of the vehicle by fusing the plurality of calculated localization values as a result of localizing the vehicle.

In various embodiments, the calculating of the plurality of localization values may include calculating a first localization value for the vehicle using a first localization technology for performing localization according to a GNSS/INS-based localization method; and calculating a second localization value for the vehicle using a second localization technology for performing localization according to a normal distribution transform (NDT) map-based localization method, the NDT map being generated by post-processing a point cloud for the predetermined region, and the determining of the position and orientation of the vehicle may include deriving position information of the vehicle and orientation information of the vehicle by fusing the calculated first localization value and the calculated second localization value.

In various embodiments, the deriving of the position information of the vehicle and the orientation information of the vehicle may include determining a localization technology-specific weight for each of a plurality of regions based on regional characteristics of each of the plurality of regions, and generating a localization technology-specific weight map using the determined localization technology-specific weight; assigning a first weight corresponding to the first localization technology to the calculated first localization value and a second weight corresponding to the second localization technology to the calculated second localization value based on the generated localization technology-specific weight map; and deriving the position information of the vehicle and the orientation information of the vehicle by fusing the first localization value to which the first weight is assigned and the second localization value to which the second weight is assigned.

In various embodiments, the calculating of the plurality of localization values may include calculating a first localization value for the vehicle using a first localization technology for performing localization according to a GNSS/INS-based localization method; calculating a second localization value for the vehicle using a second localization technology for performing localization according to a normal distribution transform (NDT) map-based localization method, the NDT map being generated by post-processing a point cloud for the predetermined region; and calculating a third localization value for the vehicle using a third localization technology for performing localization according to a lane matching-based localization method, and the determining of the position and orientation of the vehicle may include deriving position information of the vehicle and orientation information of the vehicle by fusing the calculated first localization value, the calculated second localization value, and the calculated third localization value.

In various embodiments, the calculating of the third localization value may include generating a lane precision map for the predetermined region; generating real-time lane information using a real-time point cloud acquired from the vehicle; and matching the generated lane precision map with the generated real-time lane information to calculate the third localization value for the vehicle.

In various embodiments, the generating of the lane precision map may include extracting only points corresponding to a ground surface from the point cloud acquired by scanning the predetermined region to generate a ground surface point cloud for the predetermined region; defining a range of interest (ROI) corresponding to the lane in the point cloud acquired by scanning the predetermined region to generate a range-of-interest map (ROI map) for the predetermined region; and extracting only points matched with points included in the generated ROI map and having an intensity equal to or greater than a threshold value from among a plurality of points included in the generated ground surface point cloud to generate the lane precision map for the predetermined region.

In various embodiments, the generating of the ROI map may include extracting a plurality of lane candidate points from a point cloud acquired by scanning the predetermined region based on a predefined range, the predefined range including a longitudinal range, a lateral range, a height range, and an intensity range; connecting the plurality of extracted lane candidate points based on a gradient between the plurality of extracted lane candidate points; setting a region having a predetermined size including the plurality of connected lane candidate points as a unit ROI; and combining the plurality of unit ranges of interest set for the plurality of point clouds acquired from a plurality of different frames to generate an ROI map for the predetermined region.

In various embodiments, the generating of the ROI map may include labeling lanes on the point cloud acquired by scanning the predetermined region to define a road structure for the predetermined region, thereby generating a road network map for the predetermined region; and setting an area having a predetermined size including lanes labeled on the generated road network map as the ROI to generate the ROI map for the predetermined region.

In various embodiments, the generating of the lane precision map may include extracting only points corresponding to a ground surface from the point cloud acquired by scanning the predetermined region to generate a ground surface point cloud for the predetermined region; labeling lanes in the point cloud acquired by scanning the predetermined region to define a road structure for the predetermined region, thereby generating a road network map for the predetermined region; and extracting only points located on the lane labeled on the generated road network map from among the plurality of points included in the generated ground surface point cloud to generate the lane precision map for the predetermined region.

In various embodiments, the generating of the lane precision map may include extracting a plurality of points corresponding to the lane from the point cloud acquired by scanning the predetermined region; approximating the plurality of extracted points into a line shape to acquire direction information of each of the plurality of extracted points; and generating a lane precision map including position information of each of the plurality of extracted points and direction information of each of the plurality of extracted points.

In various embodiments, the generating of the real-time lane information may include acquiring the point cloud collected in real time through a sensor included in the vehicle; setting an ROI in the acquired point cloud; extracting a plurality of points included in a predefined range from among the points included in the set ROI, the predefined range including a longitudinal range, a lateral range, a height range, and an intensity range; and connecting the plurality of extracted points based on a gradient between the plurality of extracted points to generate the real-time lane information.

In various embodiments, the setting of the ROI may include setting an ROI in a three-dimensional space shape having a predetermined size in the acquired point cloud based on any one of a position of a center point of the vehicle and a position of the sensor included in the vehicle.

In various embodiments, the setting of the ROI may include setting the ROI in the three-dimensional space shape having a predetermined size at a position corresponding to a direction in which the vehicle travels in the acquired point cloud based on the direction in which the vehicle travels.

In various embodiments, the setting of the ROI may include acquiring video data generated by filming a region in the direction in which the vehicle travels through a camera sensor included in the vehicle; analyzing the acquired video data to identify a lane; and determining a position relative to the identified lane with the vehicle as a reference, determining a position at which the ROI is set, based on the determined relative position, and setting the ROI in the three-dimensional space shape having the predetermined size at the position at which the ROI is set in the acquired point cloud.

In various embodiments, the generating of the real-time lane information may include acquiring the point cloud collected in real time through a sensor included in the vehicle; setting an ROI on the acquired point cloud; defining a ground surface within the set ROI by approximating points included in the set ROI into a plane shape; extracting a plurality of points included in a predefined range from among points located on the defined ground surface, the predefined range including a longitudinal range, a lateral range, a height range, and an intensity range; and connecting the plurality of extracted points based on a gradient between the plurality of extracted points to generate the real- time lane information.

In various embodiments, the generating of the real-time lane information may include acquiring the point cloud collected in real time through a sensor included in the vehicle; setting an ROI in the acquired point cloud; extracting a plurality of points included in a predefined range from among the points included in the set ROI, the predefined range including a longitudinal range, a lateral range, a height range, and an intensity range; acquiring direction information of each of the plurality of extracted points by approximating the plurality of extracted points into a line shape; and generating real-time lane information including the position information for each of the plurality of extracted points and the direction information of each of the plurality of extracted points.

In various embodiments, the matching of the generated lane precision map with the generated real-time lane information to calculate the third localization value for the vehicle may include deriving the position information for the vehicle and the orientation information for the vehicle by matching information included in the generated lane precision map with information included in the generated real-time lane information based on a vehicle coordinate system with a center point in the vehicle as an origin.

A computing device that performs a method for localizing an autonomous vehicle by fusing a plurality of localization technologies according to another aspect of the present invention for solving the above-described problem may include a processor; a network interface; a memory; and a computer program loaded into the memory and executed by the processor, wherein the computer program may include instructions for calculating a plurality of localization values by performing localization for a vehicle located in a predetermined region using a plurality of localization technologies for performing localization according to different localization methods; and instructions for determining a position and orientation of the vehicle by fusing the plurality of calculated localization values as a result of localizing the vehicle.

A computer program according to still another aspect of the present invention for solving the above-described problem may be combined with a computing device and stored in a recording medium readable by the computing device to execute a method for localizing an autonomous vehicle by fusing a plurality of localization technologies, the method including: calculating a plurality of localization values by performing localization for a vehicle located in a predetermined region using a plurality of localization technologies for performing localization according to different localization methods; and determining a position and orientation of the vehicle by fusing the plurality of calculated localization values as a result of localizing the vehicle.

Other specific details of the present invention are included in the detailed description and drawings.

### Advantageous Effects

According to various aspects of the present invention, there is an advantage that it is possible to derive more precise localization results by determining a position and orientation of an autonomous vehicle by fusing a plurality of localization values calculated through a plurality of localization technologies to determine a position and orientation of an autonomous vehicle.

Further, there is an advantage that it is possible to perform more precise and accurate localization in consideration of regional characteristics of a region in which an autonomous vehicle is located, by fusing a plurality of localization technologies for performing localization according to different localization methods to determine a position and orientation of the vehicle and assigning a localization technology-specific weight in consideration of the regional characteristics.

The effects of the present invention are not limited to the effects mentioned above, and other effects that are not mentioned can be clearly understood by those skilled in the art from the description below.

### DESCRIPTION OF DRAWINGS

FIG. 1 is a diagram illustrating an autonomous driving system according to an embodiment of the present invention.

FIG. 2 is a diagram illustrating a hardware configuration of a computing device that performs a method for localizing an autonomous vehicle by fusing a plurality of localization technologies according to another embodiment of the present invention.

FIG. 3 is a flowchart of a method for localizing an autonomous vehicle by fusing two localization technologies for performing localization according to different localization methods in various embodiments.

FIG. 4 is a flowchart showing a method for localizing an autonomous vehicle by fusing three localization technologies for performing localization according to different localization methods in various embodiments.

FIG. 5 is a flowchart showing a method for calculating a third localization value in various embodiments.

FIG. 6 is a flowchart showing a first method for generating a lane precision map in various embodiments.

FIG. 7 is a diagram illustrating a ground surface point cloud which is applicable to various embodiments.

FIG. 8 is a diagram illustrating a range-of-interest map which is applicable to various embodiments.

FIG. 9 is a diagram illustrating a lane precision map which is applicable to various embodiments.

FIG. 10 is a flowchart showing a first method for generating a range-of-interest map in various embodiments.

FIG. 11 is a diagram illustrating a point cloud for a predetermined region which is applicable to various embodiments.

FIG. 12 is a diagram illustrating a plurality of lane candidate points extracted from a point cloud based on a predefined range, which is applicable to various embodiments.

FIG. 13 is a diagram illustrating a plurality of interconnected lane candidate points which are applicable to various embodiments.

FIG. 14 is a diagram illustrating a unit range of interest applicable to various embodiments.

FIG. 15 is a flowchart showing a second method for generating a range-of-interest map in various embodiments.

FIG. 16 is a diagram illustrating a road network map which is applicable to various embodiments.

FIG. 17 is a flowchart showing a second method for generating a lane precision map in various embodiments.

FIG. 18 is a flowchart showing a third method for generating a lane precision map in various embodiments.

FIG. 19 is a diagram illustrating a lane precision map including position information and direction information of points, which is applicable to various embodiments.

FIG. 20 is a flowchart showing a first method for generating real-time lane information in various embodiments.

FIG. 21 is a flowchart showing a second method for generating real-time lane information in various embodiments.

FIG. 22 is a diagram illustrating a ground surface defined within a range of interest, which is applicable to various embodiments.

FIG. 23 is a diagram illustrating a plurality of points extracted from a ground surface within the range of interest based on a predefined range, which is applicable to various embodiments.

FIG. 24 is a flowchart showing a third method for generating real-time lane information in various embodiments.

FIG. 25 is a diagram illustrating real-time lane information including the position information and the direction information of a point, which is applicable to various embodiments.

FIG. 26 is a diagram illustrating a time-localization error graph for results of performing localization using a single localization technology and results of performing localization by fusing a plurality of different localization technologies in various embodiments.

### MODES OF THE INVENTION

The advantages and features of the present invention, and methods for achieving these will become apparent with reference to embodiments that will be described in detail below together with the accompanying drawings. However, the present invention is not limited to the embodiments that will be described hereinafter, but may be implemented in various different forms, the present embodiments are provided only to make the disclosure of the present invention complete and to fully inform those skilled in the art of the scope of the present invention, and the present invention is defined only by the claims.

The terms used herein are intended to describe the embodiments and are not intended to limit the present invention. In the present specification, singular forms include plural forms unless specifically stated otherwise. The terms “comprise” and/or “comprising” as used herein do not exclude the presence or addition of one or more other components in addition to mentioned components. The same signs refer to the same components throughout the specification, and “and/or” includes each of mentioned components and one or more combinations thereof. Although “first,” “second,” and the like are used to describe various components, it is obvious that these components are not limited by such terms. These terms are only used to distinguish one component from another. Therefore, it is obvious that a first component that will be mentioned hereinafter may also be a second component within the technical spirit of the present invention.

Unless otherwise defined, all terms (including technical and scientific terms) used herein may be used with meanings that can be commonly understood by those skilled in the art to which the present invention belongs. Further, terms defined in a commonly used dictionary shall not be construed ideally or excessively unless explicitly specifically defined.

The term “unit” or “module” used herein means software, or a hardware component such as an FPGA or ASIC, that performs a certain role. However, a “unit” or “module” is not limited to software or hardware. A “unit” or “module” may be configured to be in an addressable storage medium and may be configured to execute one or more processors. Thus, as an example, a “unit” or “module” includes components such as software components, object-oriented software components, class components, and task components, processes, functions, attributes, procedures, subroutines, segments of program code, drivers, firmware, microcode, circuitry, data, databases, data structures, tables, arrays, and variables. Functionalities provided within the components and the “units” or “modules” may be combined into a smaller number of components and “units” or “modules” or further separated into additional components and “units” or “modules.”

Spatially relative terms such as “below,” “beneath,” “lower,” “above,” and “upper” may be used to easily describe a correlation between one component and other components, as illustrated in the drawings. The spatially relative terms should be understood as terms including different directions of components in use or operation, in addition to directions illustrated in the drawings. For example, when components illustrated in the drawing are flipped, a component described as “below” or “beneath” another component may be placed “above” the other component. Accordingly, the exemplary term “below” may include both “below” and “above.” The components may also be oriented in other directions, and thus the spatially relative terms may be construed depending on the orientation.

In the present specification, “computer” means any of all types of hardware devices including at least one processor, and may be understood with a meaning encompassing software configurations operating on the hardware device according to an embodiment. For example, “computer” may be understood with a meaning including all of a smartphone, a tablet PC, a desktop, a laptop, and user clients and applications driven on each device, but is not limited thereto.

Hereinafter, embodiments of the present invention will be described in detail with reference to the accompanying drawings.

Although respective operations described herein will be described as being performed by the computer, subjects performing the respective operations are not limited thereto and at least some of the respective operations may be performed by different devices according to embodiments.

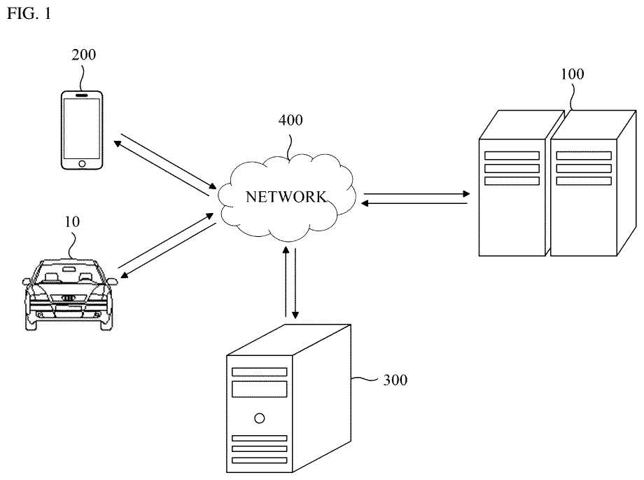

FIG. 1 is a diagram illustrating an autonomous driving system according to an embodiment of the present invention.

Referring to FIG. 1, the autonomous driving system according to the embodiment of the present invention may include a computing device 100, a user terminal 200, an external server 300, and a network 400.

Here, the autonomous driving system illustrated in FIG. 1 is an embodiment, and components thereof are not limited to those in the embodiment illustrated in FIG. 1 and may be added, changed, or deleted as needed.

In an embodiment, the computing device 100 may perform various operations for autonomous driving control of an autonomous vehicle 10.

In various embodiments, the computing device 100 may perform a localization operation for measuring a position and orientation of the autonomous vehicle 10. For example, the computing device 100 may collect sensor data from sensors (for example, lidar sensors, radar sensors, and camera sensors) included inside the autonomous vehicle 10, and utilize the collected sensor data to determine the position and orientation of the autonomous vehicle 10.

In various embodiments, the computing device 100 may determine the position and orientation of the vehicle 10 as a result of localizing the vehicle 10 by fusing a plurality of localization technologies.

For example, the computing device 100 may perform the localization for the vehicle 10 using each of the plurality of localization technologies for performing localization according to a plurality of different localization methods, to calculate a plurality of localization values (for example, position information for the vehicle 10 and orientation information for the vehicle 10), and fuse the plurality of calculated localization values to determine a final position and orientation of the vehicle 10.

Here, the position information for the vehicle 10 may be a coordinate value corresponding to the position of the vehicle 10, and the orientation information for the vehicle 10 may be a quaternion value or an Euler angle value (for example, pitch, roll, and yaw values) corresponding to the orientation of the vehicle 10, but the present invention is not limited thereto. The method for localizing an autonomous vehicle by fusing a plurality of localization technologies, which is performed by the computing device 100, will be described in detail hereinafter.

In various embodiments, the computing device 100 may be connected to the user terminal 200 through the network 400, and may provide localization results (for example, the position and orientation of the vehicle 10) derived by performing localization for the vehicle 10 to the user terminal 200.

Here, the user terminal 200 may be an infotainment system included inside the autonomous vehicle 10, but is not limited thereto and may be a wireless communication device with portability and mobility, which is a portable terminal that can be carried by a passenger inside the autonomous vehicle 10. For example, the user terminal 200 may include any of all types of handheld-based wireless communication devices such as a navigation device, a personal communication system (PCS), Global System for Mobile Communications (GSM), personal digital cellular (PDC), personal handyphone system (PHS), personal digital assistant (PDA), International Mobile Telecommunications (IMT)-2000, code division multiple access (CDMA)-2000, w-code division multiple access (W-CDMA), or wireless broadband internet (Wibro) terminal, a smartphone, a smart pad, and a tablet PC, but is not limited thereto.

Further, the network 400 here may be a connection structure in which information can be exchanged between nodes, such as a plurality of terminals and servers. Examples of the network 400 may include a local area network (LAN), a wide area network (WAN), the Internet (WWW: World Wide Web), a wired or wireless data communication network, a telephone network, and a wired and wireless television communication network.

Further, here, examples of the wireless data communication network may include 3G, 4G, 5G, 3rd Generation Partnership Project (3GPP), 5th generation partnership project (5GPP), Long Term Evolution (LTE), World Interoperability for Microwave Access (WIMAX), Wi-Fi, the Internet, a local area network (LAN), a wireless local area network (Wireless LAN), a wide area network (WAN), a personal area network (PAN), radio frequency (RF), a Bluetooth network, a near-field communication (NFC) network, a satellite broadcasting network, an analog broadcasting network, and a digital multimedia broadcasting (DMB) network, but the present invention is not limited to.

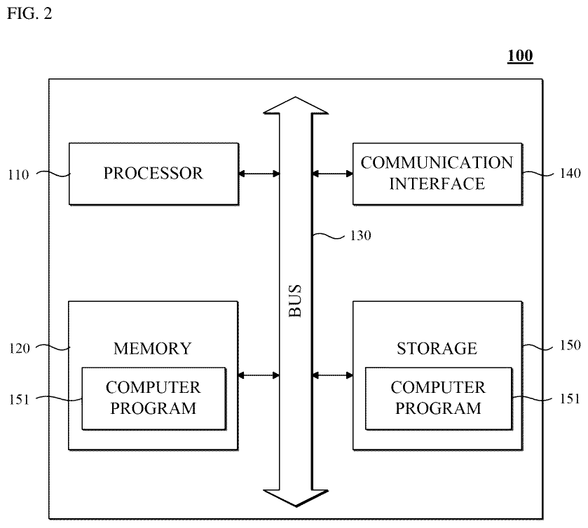

In an embodiment, the external server 300 may be connected to the computing device 100 via the network 400, and may store and manage various types of information and data required for the computing device 100 to perform the method for localizing an autonomous vehicle by fusing a plurality of localization technologies or may receive, store, and manage various types of information and data generated as the computing device 100 performs the method for localizing an autonomous vehicle by fusing a plurality of localization technologies. For example, the external server 300 may be a storage server separately included outside the computing device 100, but is not limited thereto. Hereinafter, a hardware configuration of the computing device 100 that performs the method for localizing an autonomous vehicle by fusing a plurality of localization technologies will be described with reference to FIG. 2.

FIG. 2 is a diagram illustrating a hardware configuration of the computing device that performs a method for localizing an autonomous vehicle by fusing a plurality of localization technologies according to another embodiment of the present invention.

Referring to FIG. 2, in various embodiments, the computing device 100 may include one or more processors 110, a memory 120 into which a computer program 151 that is executed by the processor 110 is loaded, a bus 130, a communication interface 140, and a storage 150 that stores the computer program 151. Here, only components related to the embodiment of the present invention are illustrated in FIG. 2. Therefore, it will be understood by those skilled in the art that other general components may be included in addition to the components illustrated in FIG. 2.

The processor 110 controls an overall operation of each component of the computing device 100. The processor 110 may be configured to include a central processing unit (CPU), a micro processor unit (MPU), a micro controller unit (MCU), a graphics processing unit (GPU), or any other type of processor well known in the art of the present invention.

Further, the processor 110 may perform computation for at least one application or program for executing methods according to embodiments of the present invention, and the computing device 100 may have one or more processors.

In various embodiments, the processor 110 may further include a random access memory (RAM; not illustrated) and a read-only memory (ROM; not illustrated) that temporarily and/or permanently store signals (or data) that are processed within the processor 110. Further, the processor 110 may be implemented in the form of a system on chip (SoC) including at least one of a GPU, a RAM, and a ROM.

The memory 120 stores various types of data, commands, and/or information. The computer program 151 from the storage 150 may be loaded into the memory 120 to execute a method or operation according to various embodiments of the present invention. When the computer program 151 is loaded into the memory 120, the processor 110 may perform the method or operation by executing one or more instructions constituting the computer program 151. The memory 120 may be implemented as a volatile memory such as a RAM, but the technical scope of the present disclosure is not limited thereto.

The bus 130 provides communication functionality between components of the computing device 100. The bus 130 may be implemented as various types of buses such as an address bus, a data bus, and a control bus.

The communication interface 140 supports wired and wireless Internet communication of the computing device 100. Further, the communication interface 140 may support various communication schemes other than Internet communication. To this end, the communication interface 140 may be configured to include a communication module well known in the technical field of the present invention. In some embodiments, the communication interface 140 may be omitted.

The storage 150 may non-temporarily store the computer program 151. When a process for localizing an autonomous vehicle by fusing a plurality of localization technologies is performed by the computing device 100, the storage 150 may store various types of information necessary to provide the process for localizing an autonomous vehicle by fusing a plurality of localization technologies.

The storage 150 may be configured to include a nonvolatile memory such as a read only memory (ROM), an erasable programmable ROM (EPROM), an electrically erasable programmable ROM (EEPROM), or a flash memory, a hard disk, a removable disk, or any type of computer-readable recording medium well known in the art to which the present invention belongs.

The computer program 151 may include one or more instructions that cause the processor 110 to perform the method or operation according to various embodiments of the present invention when loaded into the memory 120. That is, the processor 110 may perform the method or operation according to various embodiments of the present invention by executing the one or more instructions.

In an embodiment, the computer program 151 may include one or more instructions for performing a method for localizing an autonomous vehicle by fusing a plurality of localization technologies, which includes an operation of performing localization for the vehicle located in a predetermined region using a plurality of localization technologies for performing localization according to different localization methods, to calculate a plurality of localization values, and an operation of determining a position and orientation of the vehicle by fusing the plurality of calculated localization values as a result of localizing the vehicle.

The operations of the method or algorithm described in connection with the embodiments of the present invention may be implemented directly in hardware, implemented as software modules executed by hardware, or implemented by a combination thereof. The software module may reside in a RAM, a ROM, an EPROM, an EEPROM, a flash memory, a hard disk, a removable disk, a CD-ROM, or any type of computer-readable recording medium well known in the art to which the present invention belongs.

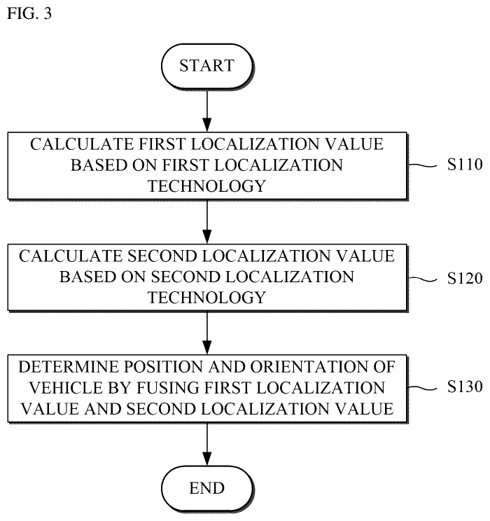

Components of the present invention may be implemented as a program (or application) to be executed in connection with a computer that is hardware, and may be stored on a medium. The components of the present invention may be executed as software programming or software elements, and similarly, the embodiments may be implemented in a programming or scripting language such as C, C++, Java, or an assembler, including various algorithms implemented as a combination of data structures, processes, routines, or other programming components. Functional aspects may be implemented as an algorithm executed on one or more processors. Hereinafter, a method for localizing an autonomous vehicle by fusing a plurality of localization technologies, which is performed by the computing device 100, will be described with reference to FIGS. 3 to 26.

FIG. 3 is a flowchart of a method for localizing an autonomous vehicle by fusing two localization technologies for performing localization according to different localization methods in various embodiments.

Referring to FIG. 3, in various embodiments, the computing device 100 may fuse two localization technologies for performing localization according to different localization methods to determine the position and orientation of the vehicle 10.

In operation S110, the computing device 100 may perform the localization for the vehicle 10 based on the first localization technology to calculate a first localization value for the vehicle 10.

In various embodiments, the computing device 100 may calculate the first localization value for the vehicle 10 using the first localization technology for performing localization according to a GNSS/INS-based localization method.

Here, the first localization value for the vehicle 10 is a value calculated as a result of performing the localization for the vehicle 10 according to the GNSS/INS-based localization method, and the first localization value may include, for example, position information of the vehicle 10 and orientation information of the vehicle 10, but is not limited thereto.

Further, various technologies are known for a method of performing localization for a specific target according to the GNSS/INS-based localization method and may be selectively applied in the GNSS/INS-based localization method according to various embodiments of the present invention, and a specific method of performing the localization for the vehicle 10 according to the GNSS/INS-based localization method is not limited herein.

In operation S120, the computing device 100 may perform the localization for the vehicle 10 based on a second localization technology to calculate a second localization value for the vehicle 10.

In various embodiments, the computing device 100 may calculate the second localization value for the vehicle 10 by using the second localization technology for performing localization according to a normal distribution transform (NDT) map-based localization method.

Here, the NDT map may be generated by postprocessing point cloud data for the predetermined region.

Further, here, the second localization value for the vehicle 10 is a value calculated as a result of performing the localization for the vehicle 10 according to the NDT map-based localization method, and the second localization value for the vehicle 10 may include, for example, the position information of the vehicle 10 and the orientation information of the vehicle 10, but is not limited thereto.

Further, here, various technologies are known for methods for performing localization for a specific target according to the NDT map-based localization method, such known technologies may be selectively applied in the NDT map-based localization method according to various embodiments of the present invention, and thus a specific method for performing the localization for the vehicle 10 according to the NDT-based localization method is not limited herein.

In operation S130, the computing device 100 may determine the position and orientation of the vehicle by fusing the first localization value calculated in operation S110 and the second localization value calculated in operation S120.

In various embodiments, the computing device 100 may calculate an average coordinate value for a coordinate value corresponding to the position of the vehicle 10 calculated based on the first localization technology and a coordinate value corresponding to the position of the vehicle 10 calculated based on the second localization technology, and determine that the calculated average coordinate value is position coordinates of the vehicle 10.

Further, the computing device 100 may calculate an average quaternion value or average Euler angle value for a quaternion value or Euler angle value corresponding to the orientation of the vehicle 10 calculated based on the first localization technology (for example, pitch, roll, and yaw values corresponding to the orientation of the vehicle 10 included in the first localization value) and a quaternion value or Euler angle value corresponding to the orientation of the vehicle 10 calculated based on the second localization technology (for example, pitch, roll, and yaw values corresponding to the orientation of the vehicle 10 included in the second localization value), and determine that the calculated average quaternion value or average Euler angle value is the orientation of the vehicle 10. However, the present invention is not limited thereto.

In various embodiments, the first localization value calculated based on the first localization technology and the second localization value calculated based on the second localization technology may be probability data and include average data and covariance data for the position and orientation of the vehicle 10, and the computing device 100 may determine the position and orientation of the vehicle 10 by fusing the first localization value calculated based on the first localization technology and the second localization value calculated based on the second localization technology through a Kalman filter.

Meanwhile, the performance and reliability of the plurality of localization technologies for performing localization according to different localization methods may be different depending on regional characteristics. For example, the accuracy of the GNSS/INS-based localization method may be degraded in a forest tunnel or a forest of buildings, and the accuracy of the NDT-based localization method may be degraded in a road environment with few landmarks.

Considering these points, the computing device 100 may determine the position and orientation of the vehicle 10 by assigning a weight to each of the plurality of localization values in consideration of regional characteristics of the predetermined region in which the vehicle 10 is located and fusing the plurality of localization values to which the weights are assigned.

More specifically, first, the computing device 100 may generate a localization technology-specific weight map (localization locality map: LLM). For example, the computing device 100 may determine a localization technology-specific weight for each of the plurality of regions based on regional characteristics of each of the plurality of regions, and generate the localization technology-specific weight map using the determined localization technology-specific weight.

Here, the localization technology-specific weight for each of the plurality of regions may be a value that is individually determined for each localization technology according to the performance, accuracy, and reliability within the plurality of regions based on the regional characteristics of each of the plurality of regions.

For example, in a forest tunnel or a forest of buildings, the accuracy of the GNSS/INS-based localization method may be degraded, and a higher weight may be set for the NDT map-based localization method than the GNSS/INS-based localization method in the forest tunnel or forest of buildings. Further, in a road environment with few landmarks, the accuracy of the NDT-based localization method may be degraded, and a higher weight may be set for the GNSS/INS-based localization method than the NDT map-based localization method in the road environment with few landmarks.

Thereafter, the computing device 100 may assign the first weight corresponding to the first localization technology to the first localization value and the second weight corresponding to the second localization technology to the second localization value based on the localization technology-specific weight map. For example, when the vehicle 10 is located in a specific region, the computing device 100 may load the localization technology-specific weight corresponding to the specific region (for example, the first weight corresponding to the first localization technology and the second weight corresponding to the second localization technology) from the localization technology-specific weight map, and assign the first weight and the second weight to the first localization value and the second localization value calculated using the first localization technology and the second localization technology.

Thereafter, the computing device 100 may determine the position and orientation of the vehicle by fusing the first localization value to which the first weight is assigned and the second localization value to which the second weight is assigned.

For example, the computing device 100 may calculate an average coordinate value for a first coordinate value to which the first weight is assigned (a coordinate value corresponding to the position of the vehicle 10 included in the first localization value) and a second coordinate value to which the second weight is assigned (a coordinate value corresponding to the position of the vehicle 10 included in the second localization value), and may determine that the calculated average coordinate value is position coordinates of the vehicle 10.

Further, the computing device 100 may calculate an average quaternion value or average Euler angle value for a first quaternion value or first Euler angle value to which the first weight is assigned (pitch, roll, and yaw values corresponding to the orientation of the vehicle 10 included in the first localization value) and a second quaternion value or second Euler angle value to which the second weight is assigned (pitch, roll, and yaw values corresponding to the orientation of the vehicle 10 included in the second localization value), and determine that the calculated average quaternion value or average Euler angle value is the orientation of the vehicle 10. However, the present invention is not limited thereto.

In an embodiment, the first localization value calculated based on the first localization technology and the second localization value calculated based on the second localization technology may be probability data and include the average data and covariance data for the position and orientation of the vehicle 10, and the computing device 100 may determine the position and orientation of the vehicle by fusing the first localization value to which the first weight is assigned and the second localization value to which the second weight is assigned through the Kalman filter. For example, the computing device 100 may determine the position and orientation of the vehicle by tuning the covariance value included in the first localization value using the first weight, tuning the covariance value included in the second localization value using the second weight, and then fusing the resultant values through the Kalman filter.

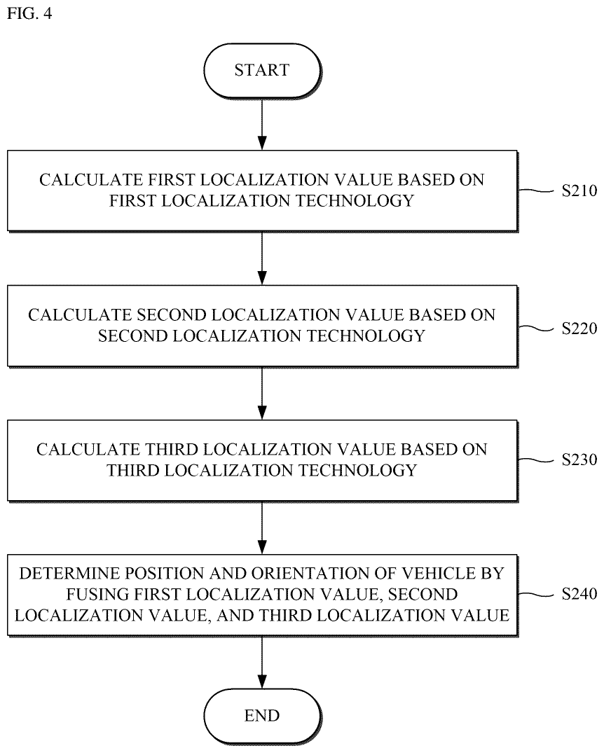

FIG. 4 is a flowchart showing a method for localizing an autonomous vehicle by fusing three localization technologies for performing localization according to different localization methods in various embodiments.

Referring to FIG. 4, in various embodiments, the computing device 100 may determine the position and orientation of the vehicle 10 by fusing three localization technologies for performing localization according to different localization methods.

In operation S210, the computing device 100 may perform the localization for the vehicle 10 based on the first localization technology to calculate the first localization value for the vehicle 10. Here, the operation of calculating the first localization value may be implemented in a form identical or similar to the first localization value calculating method performed in operation S110 of FIG. 3, but is not limited thereto.

In operation S220, the computing device 100 may perform the localization for the vehicle 10 based on the second localization technology to calculate the second localization value for the vehicle 10. Here, the operation of calculating the second localization value may be implemented in a form identical or similar to the second localization value calculating method performed in operation $120 of FIG. 3, but is not limited thereto.

In operation S230, the computing device 100 may perform the localization for the vehicle 10 based on a third localization technology to calculate a third localization value for the vehicle 10.

In various embodiments, the computing device 100 may calculate the third localization value for the vehicle 10 by using the third localization technology for performing localization according to a lane matching-based localization method.

Here, the third localization value is a value calculated as a result of performing the localization for the vehicle 10 according to the lane matching-based localization method, and the third localization value may include, for example, the position information of the vehicle 10 and the orientation information of the vehicle 10, but is not limited thereto.

In operation S240, the computing device 100 may determine the position and orientation of the vehicle by fusing the first localization value calculated in operation S210, the second localization value calculated in operation S220, and the third localization value calculated in operation S230.

For example, the computing device 100 may calculate an average coordinate value for a coordinate value corresponding to the position of the vehicle 10 calculated based on the first localization technology, a coordinate value corresponding to the position of the vehicle 10 calculated based on the second localization technology, and a coordinate value corresponding to the position of the vehicle 10 calculated based on the third localization technology, and determine that the calculated average coordinate value is position coordinates of the vehicle 10.

Further, the computing device 100 may calculate an average quaternion value or average Euler angle value for a quaternion value or Euler angle value corresponding to the orientation of the vehicle 10 calculated based on the first localization technology (for example, pitch, roll, and yaw values corresponding to the orientation of the vehicle 10 included in the first localization value), a quaternion value or Euler angle value corresponding to the orientation of the vehicle 10 calculated based on the second localization technology (for example, pitch, roll, and yaw values corresponding to the orientation of the vehicle 10 included in the second localization value), and a quaternion value or Euler angle value corresponding to the orientation of the vehicle 10 calculated based on the third localization technology (for example, pitch, roll, and yaw values corresponding to the orientation of the vehicle 10 included in the third localization value), and determine that the calculated average quaternion value or average Euler angle value is the orientation of the vehicle 10. However, the present invention is not limited thereto.

In various embodiments, the first localization value calculated based on the first localization technology, the second localization value calculated based on the second localization technology, and the third localization value calculated based on the third localization technology may be probability data and include average data and covariance data for the position and orientation of the vehicle 10, and the computing device 100 may determine the position and orientation of the vehicle 10 by fusing the first localization value calculated based on the first localization technology, the second localization value calculated based on the second localization technology, and the third localization value calculated based on the third localization technology through the Kalman filter.

In various embodiments, the computing device 100 may determine the position and orientation of the vehicle 10 by assigning a weight to each of the plurality of localization values in consideration of regional characteristics of the predetermined region in which the vehicle 10 is located and fusing the plurality of localization values to which the weights are assigned. For example, the computing device 100 may assign the first weight corresponding to the first localization technology to the first localization value, the second weight corresponding to the second localization technology to the second localization value, and the third weight corresponding to the third localization technology to the third localization value based on the localization technology-specific weight map, and fuse the first localization value to which the first weight is assigned, the second localization value to which the second weight is assigned, and the third localization value to which the third weight is assigned, to determine the position and orientation of the vehicle.

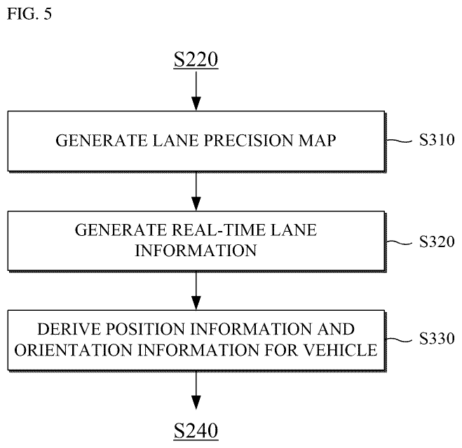

In an embodiment, the first localization value calculated based on the first localization technology, the second localization value calculated based on the second localization technology, and the third localization value calculated based on the third localization technology may be probability data and include the average data and covariance data for the position and orientation of the vehicle 10, and the computing device 100 may determine the position and orientation of the vehicle by fusing the first localization value to which the first weight is assigned, the second localization value to which the second weight is assigned, and the third localization value to which the third weight is assigned through the Kalman filter. For example, the computing device 100 may determine the position and orientation of the vehicle by tuning the covariance value included in the first localization value using the first weight, tuning the covariance value included in the second localization value using the second weight, and tuning the covariance value included in the third localization value using the third weight, and then fusing the resultant values through the Kalman filter. Hereinafter, a method for calculating the third localization value, which is performed by the computing device 100, will be described in greater detail with reference to FIGS. 5 to 25.

FIG. 5 is a flowchart showing a method for calculating the third localization value in various embodiments.

Referring to FIG. 5, in operation S310, the computing device 100 may generate a lane precision map for the predetermined region.

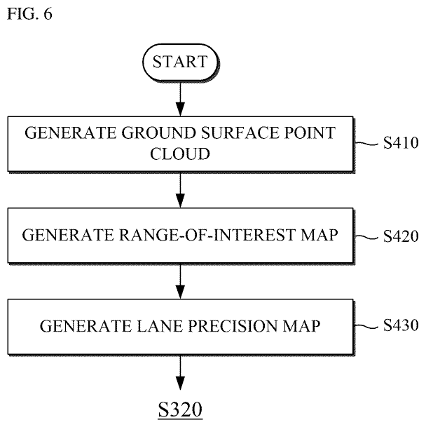

Here, the lane precision map (lane point cloud: LPC) for the predetermined region is a precision map in which lane information for the predetermined region has been stored in advance, and may be created based on a point cloud collected by scanning the predetermined region through a sensor. Hereinafter, various methods for generating the lane precision map will be described with reference to FIGS. 6 to 19.

FIG. 6 is a flowchart showing a first method for generating the lane precision map in various embodiments.

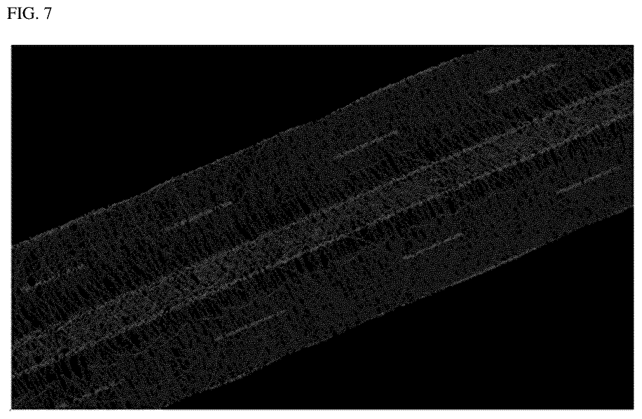

In operation S410, the computing device 100 may extract only points corresponding to a ground surface from the point cloud acquired by scanning the predetermined region (for example, a lidar point cloud acquired by scanning the predetermined region through a lidar sensor) to generate the ground surface point cloud (SPC) for the predetermined region (for example, FIG. 7).

For example, the computing device 100 may label an attribute (for example, type) of each of a plurality of points included in a point cloud for the predetermined region collected in advance, and extract only points labeled as a ground surface from among the plurality of points included in the point cloud for the predetermined region to generate the ground surface point cloud.

As another example, the computing device 100 may analyze the point cloud for the predetermined region collected in advance through a pre-trained artificial intelligence model, to extract the ground surface point cloud, that is, the ground surface point cloud including only points corresponding to the ground surface, from the point cloud for the predetermined region.

Here, the pre-trained artificial intelligence model may be a model that is supervisedly trained with a plurality of point clouds in which attributes of a plurality of points are labeled as learning data, which is a model for selecting and extracting only points corresponding to a ground surface among a plurality of points included in input data, as result data, with a point cloud acquired by scanning a specific region as the input data, but is not limited thereto.

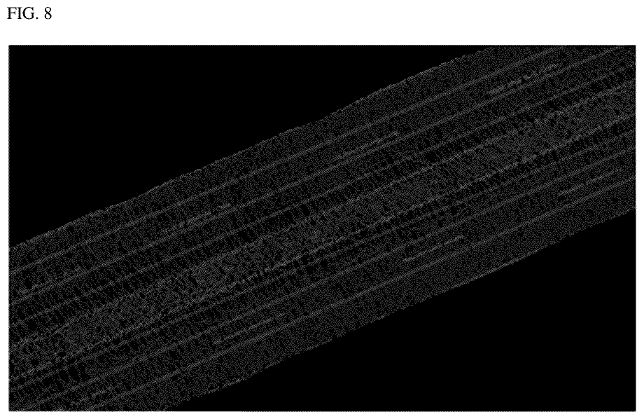

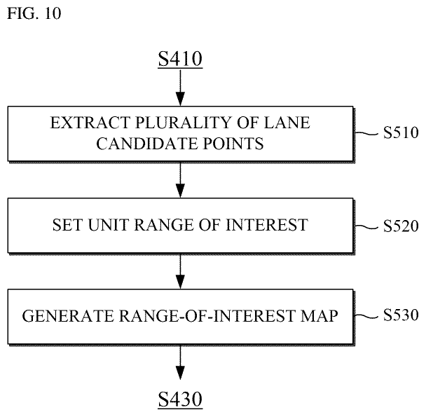

In operation S420, the computing device 100 may generate the range-of-interest map (for example, FIG. 8) for the predetermined region. For example, the computing device 100 may define a range of interest (ROI) corresponding to the lane on the point cloud acquired by scanning the predetermined region to generate the range-of-interest map (ROI map) for the predetermined region. That is, the computing device 100 may generate the ROI map which is a map in which a lane area for the predetermined region is defined as the ROI in advance. Hereinafter, a method of generating the ROI map will be described with reference to FIGS. 10 to 16.

FIG. 10 is a flowchart showing a first method of generating the ROI map in various embodiments.

Referring to FIG. 10, in operation S510, the computing device 100 may extract a plurality of lane candidate points from the point cloud for the predetermined region.

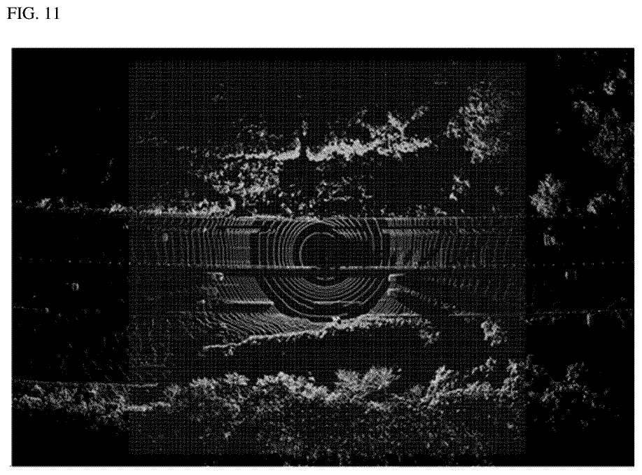

More specifically, first, the computing device 100 may scan the predetermined region to acquire the point cloud for the predetermined region (for example, FIG. 11).

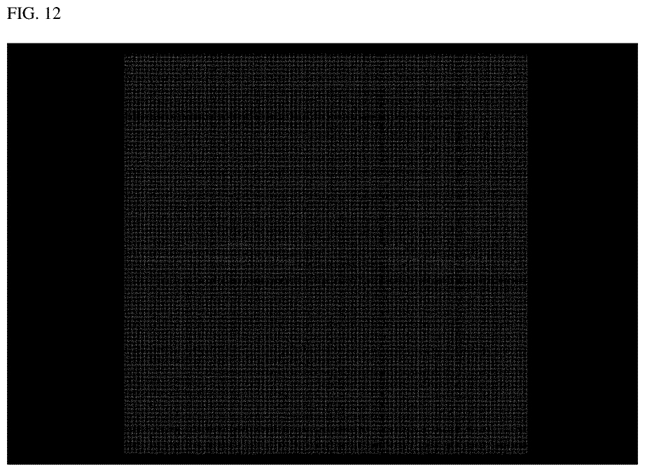

Thereafter, the computing device 100 may extract the plurality of lane candidate points (for example, FIG. 12) from the point cloud for the predetermined region.

In various embodiments, the computing device 100 may extract the plurality of lane candidate points from the point cloud for the predetermined region through a range filter.

Here, the range filter may be a filter that extracts only points included in a predefined range among the plurality of points included in the point cloud and, for example, the range filter may be a filter that extracts only points included in a longitudinal range (X range), a lateral range (Y range), a height range (Z range), and an intensity range from a reference position among the plurality of points.

That is, the computing device 100 may pass the point cloud for the predetermined region through a range filter in which a range for setting lanes is set, to thereby extract only points included in a predefined range for setting lanes as the plurality of lane candidate points.

In operation S520, the computing device 100 may set a unit ROI (ROI polygon) using the plurality of lane candidate points extracted in operation S510.

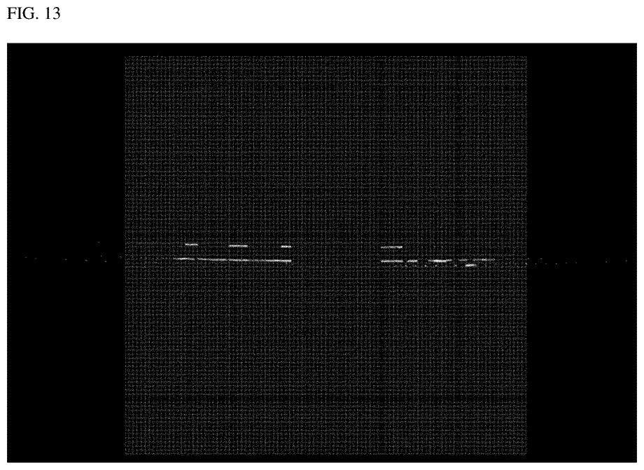

More specifically, first, the computing device 100 may connect the plurality of lane candidate points (for example, FIG. 13) based on an interpolation. For example, the computing device 100 may connect the plurality of lane candidate points based on a gradient between the plurality of lane candidate points. For example, the computing device 100 may connect two different lane candidate points among the plurality of lane candidate points when a gradient between the two different lane candidate points is equal to or smaller than a threshold value. However, the present invention is not limited thereto.

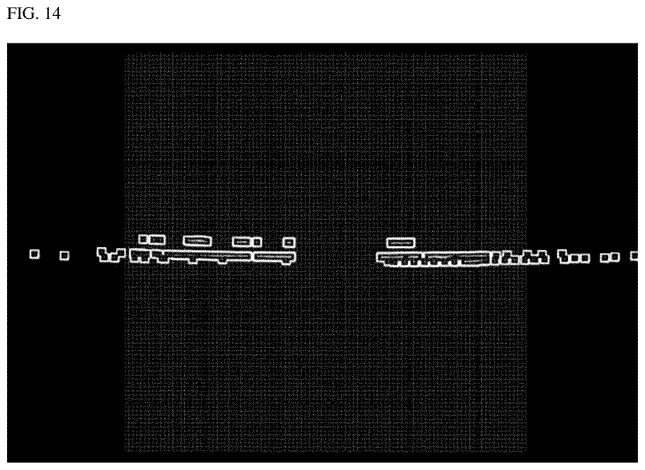

Thereafter, the computing device 100 may set a unit ROI (for example, FIG. 14) based on the plurality of interconnected lane candidate points. For example, the computing device 100 may set, as the unit ROI, a region having a predetermined size including the plurality of interconnected lane candidate points, which is centered on the plurality of interconnected lane candidate points.

In operation S530, the computing device 100 may generate the ROI map for the predetermined region using the unit ROI set in operation S520.

For example, the computing device 100 may perform operations S510 and S520 above on each of a plurality of point clouds acquired from each of a plurality of different frames to set the unit ROI for each of the plurality of point clouds, and may combine the unit ranges of interest for the plurality of point clouds to generate the ROI map (for example, FIG. 8) for the predetermined region.

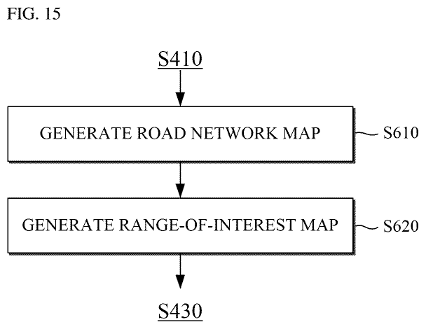

FIG. 15 is a flowchart showing a second method for generating an ROI map in various embodiments.

Referring to FIG. 15, in operation S610, the computing device 100 may generate a road network map (RNM) for the predetermined region.

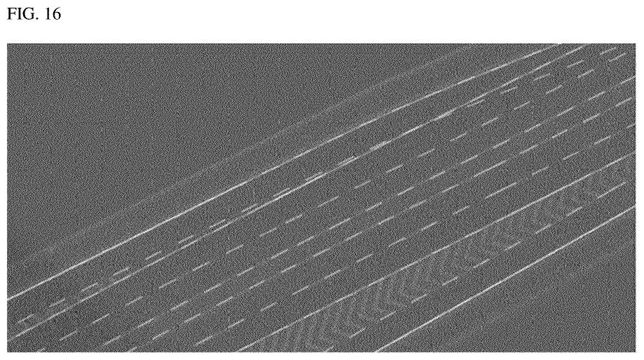

In various embodiments, the computing device 100 may label lanes on the point cloud acquired by scanning the predetermined region to define a road structure for the predetermined region, thereby generating the RNM (for example, FIG. 16) for the predetermined region.

In operation S620, the computing device 100 may generate the ROI map using the RNM generated in operation S610. For example, the computing device 100 may set an area having a predetermined size including lanes as the ROI based on the lane labeled on the RNM to generate the ROI map for the predetermined region. However, the present invention is not limited thereto.

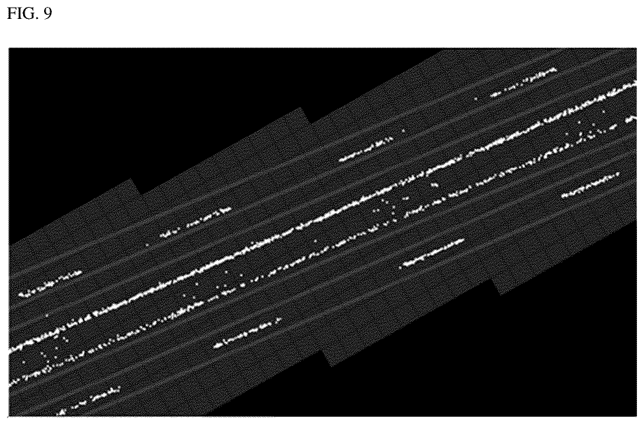

Referring back to FIG. 6, in operation S430, the computing device 100 may generate a lane precision map (for example, FIG. 9) using the ground surface point cloud generated in operation S410 and the ROI map generated in operation S420.

In various embodiments, the computing device 100 may extract only points matched with points included in the ROI map and having an intensity equal to or greater than a threshold value (for example, a value of intensity of a signal that is reflected and returned) from among a plurality of points included in the ground surface point cloud (a plurality of ground surface points) for the predetermined region, that is, extract only points corresponding to the lane from the ground surface point cloud based on the ROI map including information on the lane, to thereby generate the lane precision map for the predetermined region.

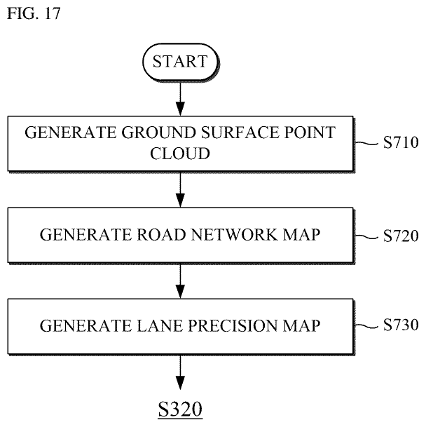

FIG. 17 is a flowchart showing a second method for generating the lane precision map in various embodiments.

Referring to FIG. 17, in operation S710, the computing device 100 may extract only points corresponding to the ground surface from the point cloud acquired by scanning the predetermined region to generate a ground surface point cloud for the predetermined region (for example, FIG. 7). Here, the operation of generating the ground surface point cloud may be implemented in a form identical or similar to the operation of generating the ground surface point cloud performed in operation S410 of FIG. 6, but is not limited thereto.

In operation S720, the computing device 100 may generate an RNM (for example, FIG. 16) for the predetermined region. Here, the operation of generating the RNM may be implemented in a form identical or similar to the operation of generating the RNM performed in operation S610 of FIG. 15, but is not limited thereto.

In operation S730, the computing device 100 may generate the lane precision map (for example, FIG. 9) using the ground surface point cloud generated in operation S710 and the RNM generated in operation S720.

In various embodiments, the computing device 100 may extract only points located on the lane labeled on the RNM among a plurality of points included in the ground surface point cloud (for example, a plurality of ground surface points) to generate the lane precision map for the predetermined region.

That is, the computing device 100 may extract only the points corresponding to the lane from the ground surface point cloud using the RNM in which the road structure is defined, to generate the lane precision map for the predetermined region.

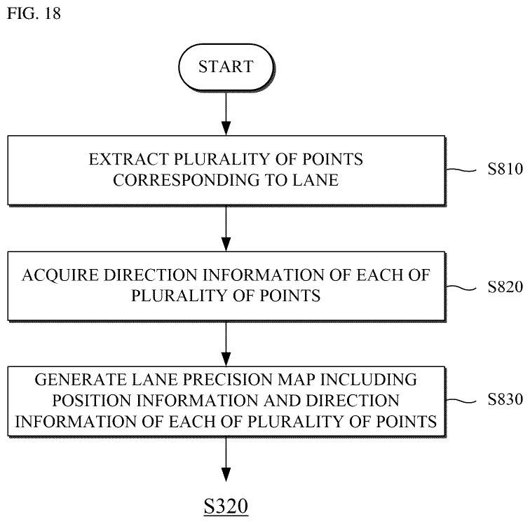

FIG. 18 is a flowchart showing a third method for generating a lane precision map in various embodiments.

Referring to FIG. 18, in operation S810, the computing device 100 may extract a plurality of points corresponding to a lane from the point cloud for the predetermined region.

For example, the computing device 100 may extract only points corresponding to the ground surface from the point cloud acquired by scanning the predetermined region to generate the ground surface point cloud, may generate the ROI map for the predetermined region, and may extract only points matched with the points included in the ROI map and having an intensity equal to or greater than the threshold value from among the plurality of points included in the ground surface point cloud (for example, a plurality of ground surface points) using the ground surface point cloud and the ROI map.

As another example, the computing device 100 may extract only points corresponding to the ground surface from the point cloud acquired by scanning the predetermined region to generate the ground surface point cloud, may generate the road network map for the predetermined region, and may extract only the points located on the lane labeled on the RNM from among the plurality of points included in the ground surface point cloud (for example, a plurality of ground surface points) using the ground surface point cloud and the road network map.

In operation S820, the computing device 100 may acquire direction information 0 of each of the plurality of points extracted in operation S810, that is, a plurality of points corresponding to the lane.

Here, the direction information may include information on a direction in which the lane extends, but is not limited thereto.

In various embodiments, the computing device 100 may acquire the direction information of each of the plurality of points using a random sample consensus (RANSAC) algorithm. For example, the computing device 100 may acquire the direction information of each of the plurality of points corresponding to the lane by gridding and sampling the plurality of points using the RANSAC algorithm to approximate the plurality of points into a line shape.

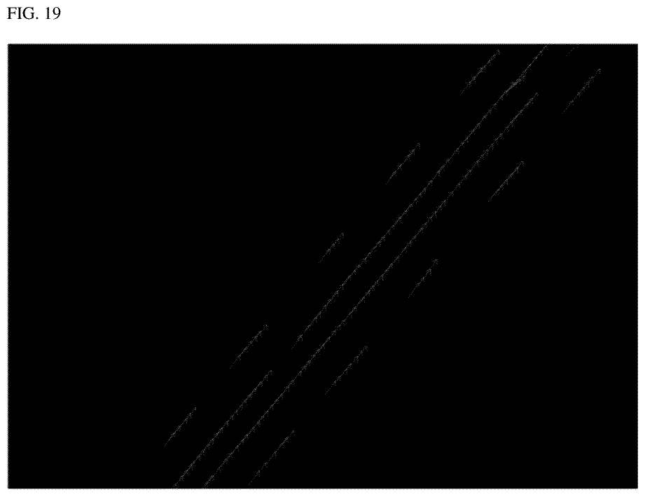

In operation S830, the computing device 100 may generate a lane precision map including position information of each of the plurality of points (for example, position coordinates X, Y, and Z of each of the plurality of points) and the direction information 0 of each of the plurality of points, to thereby generate a lane precision map (sampled LPC: S-LPC) including the position information and the direction information (for example, FIG. 19).

That is, the lane precision map including not only the coordinate values of points corresponding to the position of the lane but also the direction information is generated as described above, such that the accuracy of localization in a heading direction and a lateral direction of the vehicle can be improved.

Referring back to FIG. 5, in operation S320, the computing device 100 may generate real-time lane information using a real-time point cloud acquired from the vehicle 10.

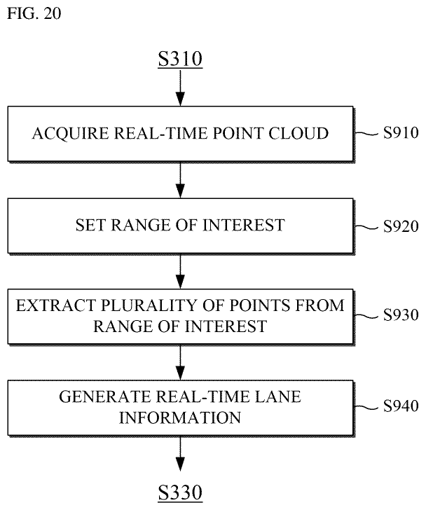

In various embodiments, the computing device 100 may acquire the real-time point cloud collected in real time through a sensor (for example, a lidar sensor) included in the vehicle 10, and may generate the real-time lane information by extracting only the points corresponding to the lane from the acquired real-time point cloud. Hereinafter, a specific method of generating the real-time lane information will be described with reference to FIGS. 20 to 25.

FIG. 20 is a flowchart showing a first method of generating the real-time lane information in various embodiments.

Referring to FIG. 20, in operation S910, the computing device 100 may acquire the real-time point cloud for the predetermined region. For example, the computing device 100 may acquire the real-time point cloud collected in real time through a sensor included in the vehicle 10 (for example, a lidar point cloud collected in real time through a lidar sensor). However, the present invention is not limited thereto.

In operation S920, the computing device 100 may set an ROI in the real-time point cloud acquired in operation S910.

In various embodiments, the computing device 100 may set an ROI in a three-dimensional space shape having a predetermined size in the real-time point cloud based on any one of a position of a center point of the vehicle 10, a position of a point within the vehicle 10, and a position of the sensor included in the vehicle 10. For example, the computing device 100 may set X, Y, and Z ranges (for example, ±50 m in an X direction, ±10 m in a Y direction, and ±3 m in a Z direction) corresponding to the ROI in the real-time point cloud based on any one of the position of the center point of the vehicle 10 and the position of the sensor included in the vehicle 10, thereby setting an ROI in a cuboid-shape in the real-time point cloud.

In various embodiments, the computing device 100 may set the ROI in the three-dimensional space shape having the predetermined size at a position corresponding to a direction in which the vehicle 10 travels (heads) in the real-time point cloud based on the direction in which the vehicle travels.

In various embodiments, the computing device 100 may analyze video data generated by filming a region in the direction in which the vehicle 10 travels to set the ROI in the three-dimensional space shape having the predetermined size in the real-time point cloud.

More specifically, first, the computing device 100 may acquire the video data generated by filming the area in the direction in which the vehicle 10 travels through a camera sensor included in the vehicle 10, and analyze the acquired video data to identify a lane. For example, the video data is analyzed based on an artificial intelligence model trained with a plurality of video data in which lanes are labeled as learning data, thereby identifying the lane in the video data. However, the present invention is not limited thereto.

Thereafter, the computing device 100 may determine a position relative to the lane identified through the video data analysis with the vehicle 10 as a reference, determine a position at which the ROI is set, based on the determined relative position, and set the ROI in the three-dimensional space shape having the predetermined size at the position at which the ROI is set in the real-time point cloud.

In operation S930, the computing device 100 may extract the points corresponding to the lane from among the points included in the ROI using the ROI set in operation S920.

In various embodiments, the computing device 100 may extract the plurality of points corresponding to the lane from among the points included in the ROI through the range filter. For example, the computing device 100 may extract only the points corresponding to the lane from among the points included in the ROI by inputting the points included in the ROI to the range filter, which filters points according to a predefined range (for example, a direction range, a lateral range, a height range, and an intensity range).

In operation S940, the computing device 100 may generate the real-time lane information using the plurality of points extracted in operation S930. For example, the computing device 100 may connect the plurality of points based on a gradient between the plurality of points. For example, the computing device 100 may connect two different points among the plurality of points when a gradient between the two different points is equal to or smaller than a threshold value.

That is, the computing device 100 may define the lane included in the real-time point cloud by connecting the plurality of points into a single line according to the gradient between the plurality of points, and generate the real-time lane information including information on the defined lane (for example, position coordinates of the points corresponding to the lane).

The ROI set to acquire the real-time lane information from the real-time point cloud is set to be consistent according to a certain criterion for the purpose of ensuring real-time performance, thereby minimizing the amount of computation while tolerating noise to some extent, unlike the ROI map (for example, FIG. 8) generated in operation S420 of FIG. 6.

Meanwhile, when the ROI is set to be narrow in order to ensure the real-time performance, the lane may not be correctly identified because the ground surface is not included in the ROI or only a part of the ground surface is included, and when the ROI is extended in consideration of this problem, there is a problem that the lane is likely not to be accurately identified due to noise.

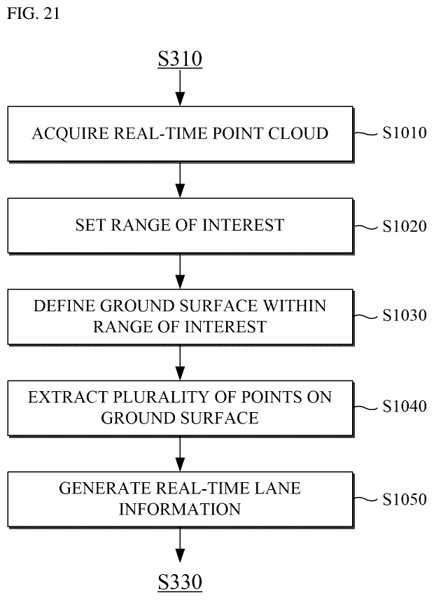

Considering this point, the computing device 100 may define the ground surface for the ROI, and may extract the points corresponding to the lane using only points included in the range defined as the ground surface. Hereinafter, this will be described with reference to FIGS. 21 to 23.

FIG. 21 is a flowchart showing a second method for generating the real-time lane information in various embodiments.

Referring to FIG. 21, in operation S1010, the computing device 100 may acquire the real-time point cloud for the predetermined region. Here, the operation of acquiring the real-time point cloud may be implemented in a form identical or similar to the real-time point cloud acquisition operation performed in operation S910 of FIG. 20.

In operation S1020, the computing device 100 may set an ROI in the real-time point cloud acquired in operation S1010. Here, the operation of setting the ROI in the real-time point cloud may be implemented in the same form as the operation of setting the ROI performed in operation S920 of FIG. 20 or a or similar form.

In operation S1030, the computing device 100 may define the ground surface within the ROI set in operation S1020 (ground segmentation).

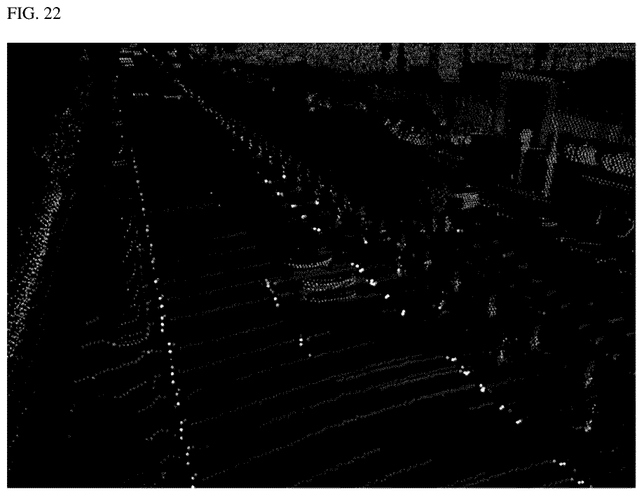

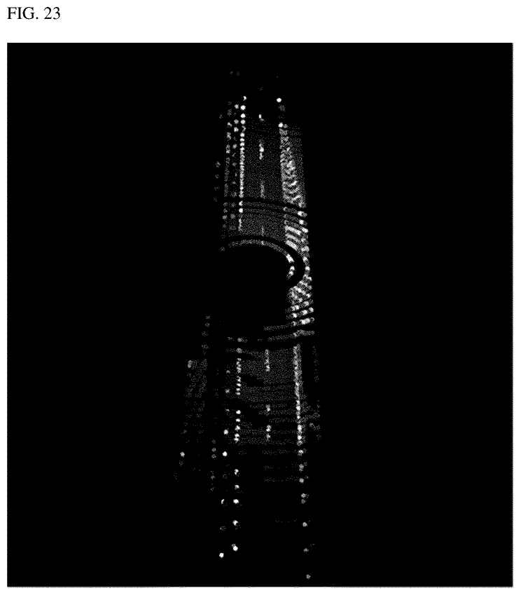

In various embodiments, the computing device 100 may define the ground surface within the ROI (for example, FIGS. 22 and 23) by approximating a plurality of points included in the ROI among the points included in the real-time point cloud into a plane shape. For example, the computing device 100 may define the ground surface within the ROI by gridding and sampling the plurality of points corresponding to the lane using the RANSAC algorithm to approximate the plurality of points into the plane shape.

In operation S1040, the computing device 100 may extract the points corresponding to the lane from among the points located on the ground surface using the ground surface defined in operation S1030.

In various embodiments, the computing device 100 may extract the plurality of points corresponding to the lane from among the points located on the ground surface through the range filter. For example, the computing device 100 may extract only the points corresponding to the lane from among the points located on the ground surface by inputting the points located on the ground surface to the range filter, which filters points according to a predefined range (for example, a direction range, a lateral range, a height range, and an intensity range).

In operation S1050, the computing device 100 may generate the real-time lane information using the plurality of points extracted in operation S1040. For example, the computing device 100 may connect the plurality of points based on the gradient between the plurality of points. For example, the computing device 100 may connect two different points among the plurality of points when a gradient between the two different points is equal to or smaller than a threshold value.

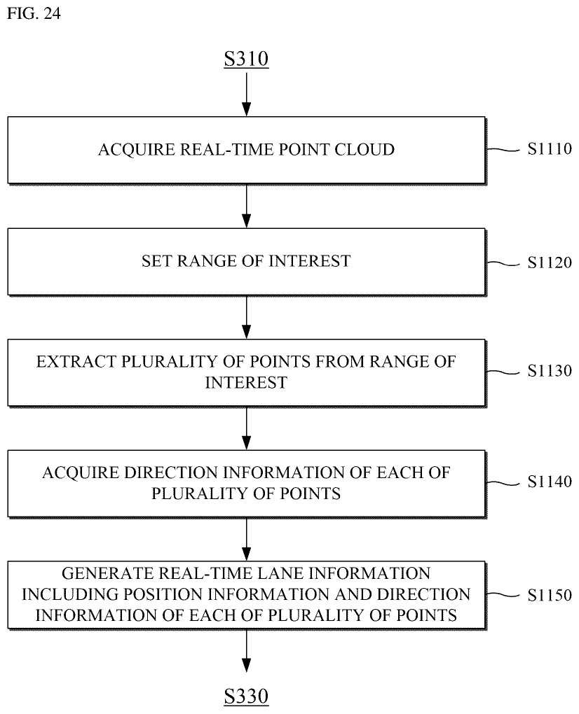

FIG. 24 is a flowchart showing a third method for generating the real-time lane information in various embodiments.

Referring to FIG. 24, in operation S1110, the computing device 100 may acquire the real-time point cloud for the predetermined region. Here, the operation of acquiring the real-time point cloud may be implemented in a form identical or similar to the operation of acquiring the real-time point cloud performed in operation S910 of FIG. 20.

In operation S1120, the computing device 100 may set an ROI on the real-time point cloud acquired in operation S1110. Here, the operation of setting the ROI on the real-time point cloud may be implemented in a form identical or similar to the operation of setting the ROI performed in operation S920 of FIG. 20.

In operation S1130, the computing device 100 may extract the points corresponding to the lane from among the points included in the ROI using the ROI set in operation S1120. Here, the operation of extracting the points corresponding to the lane from among the points included in the region may be implemented in a form identical or similar to the operation of extracting the points corresponding to the lane performed in operations S930 of FIGS. 20 and S1030 and S1040 of FIG. 21.

In operation S1140, the computing device 100 may acquire the direction information θ of each of the plurality of points extracted in operation S1130.

In various embodiments, the computing device 100 may acquire the direction information of each of the plurality of points using a RANSAC algorithm. For example, the computing device 100 may acquire the direction information of each of the plurality of points corresponding to the lane by gridding and sampling the plurality of points using the RANSAC algorithm to approximate the plurality of points into a line shape.

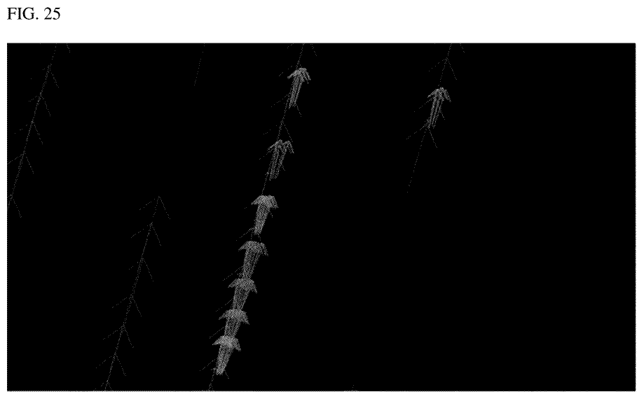

In operation S1150, the computing device 100 may generate the real-time lane information (for example, FIG. 25) using the position information of the plurality of points extracted in operation S1130 and the direction information of the plurality of points acquired in operation S1140.

Referring back to FIG. 5, in operation S330, the computing device 100 may calculate the third localization value including the position information and orientation information for the vehicle using the lane precision map generated in operation S310 and the real-time lane information generated in operation S320.

For example, the computing device 100 may determine the position and orientation of the vehicle 10 by matching the points included in the lane precision map with the points included in the real-time lane information (for example, point-to-point matching (P2P matching)).

As another example, the computing device 100 may determine the position and orientation of the vehicle 10 by matching the points included in the lane precision map with the lane included in the real-time lane information (for example, point-to-lane matching (P2L matching)).

As another example, the computing device 100 may determine the position and orientation of the vehicle 10 by matching the lane included in the lane precision map with the lane included in the real-time lane information (for example, lane-to-lane matching (L2L matching)).

In various embodiments, the computing device 100 may calculate the position information of the vehicle 10 (for example, the coordinate values corresponding to the position of the vehicle 10) and the orientation information of the vehicle 10 (for example, a quaternion value or an Euler angle value (pitch, roll, and yaw values) corresponding to the orientation of the vehicle 10), by matching information included in the lane precision map with information included in the real-time lane information, based on a vehicle coordinate system with the center point of the vehicle 10 as an origin.

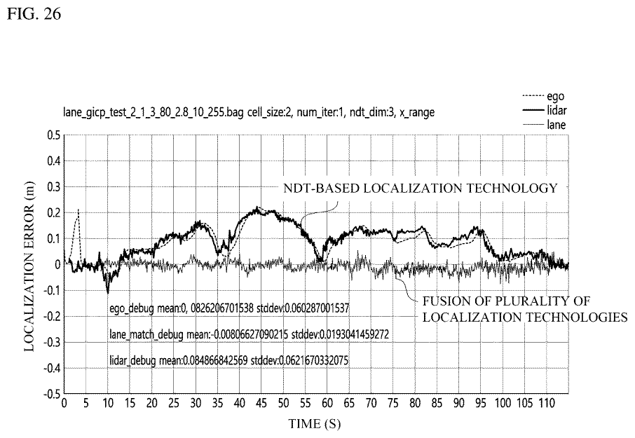

As illustrated in FIG. 26, when the localization for the vehicle 10 is performed by fusing the plurality of localization technologies, there are advantages that it is possible to improve the localization accuracy and robustness compared to results of performing the localization for the vehicle 10 through a single localization technology (for example, NDT map-based localization technology), and to improve the reliability of the autonomous driving control for the vehicle 10 since accurate localization results are derived.

A method for localizing an autonomous vehicle by fusing a plurality of localization technologies has been described above with reference to the flowcharts illustrated in the drawings. The method for localizing an autonomous vehicle by fusing a plurality of localization technologies has been illustrated and described as a series of blocks for simplicity of the description, but an order of the blocks is not limited in the present invention, and some blocks may be performed in a different order from that illustrated and described the present specification or may be performed simultaneously. Further, new blocks not described in the present specification and drawings may be added, or some blocks may be deleted or changed.

Although the embodiments of the present invention have been described above with reference to the accompanying drawings, it will be understood by those skilled in the art that it is possible to implement the present invention in other specific forms without changing the technical spirit or essential features of the present invention. Therefore, the embodiments described above should be understood as illustrative in all respects and not as restrictive.

1. A method for localizing an autonomous vehicle by fusing a plurality of localization technologies, which is performed by a computing device, the method comprising:
calculating a plurality of localization values by performing localization for a vehicle located in a predetermined region using a plurality of localization technologies for performing localization according to different localization methods; and
determining a position and orientation of the vehicle by fusing the plurality of calculated localization values as a result of localizing the vehicle.

2. The method for localizing an autonomous vehicle by fusing a plurality of localization technologies of claim 1, wherein
the calculating of the plurality of localization values includes
calculating a first localization value for the vehicle using a first localization technology for performing localization according to a GNSS/INS-based localization method; and
calculating a second localization value for the vehicle using a second localization technology for performing localization according to a normal distribution transform (NDT) map-based localization method, the NDT map being generated by post-processing a point cloud for the predetermined region, and
the determining of the position and orientation of the vehicle includes
deriving position information of the vehicle and orientation information of the vehicle by fusing the calculated first localization value and the calculated second localization value.

3. The method for localizing an autonomous vehicle by fusing a plurality of localization technologies of claim 2, wherein the deriving of the position information of the vehicle and the orientation information of the vehicle includes
determining a localization technology-specific weight for each of a plurality of regions based on regional characteristics of each of the plurality of regions, and generating a localization technology-specific weight map using the determined localization technology-specific weight;
assigning a first weight corresponding to the first localization technology to the calculated first localization value and a second weight corresponding to the second localization technology to the calculated second localization value based on the generated localization technology-specific weight map; and
deriving the position information of the vehicle and the orientation information of the vehicle by fusing the first localization value to which the first weight is assigned and the second localization value to which the second weight is assigned.

4. The method for localizing an autonomous vehicle by fusing a plurality of localization technologies of claim 1, wherein
the calculating of the plurality of localization values includes
calculating a first localization value for the vehicle using a first localization technology for performing localization according to a GNSS/INS-based localization method;
calculating a second localization value for the vehicle using a second localization technology for performing localization according to a normal distribution transform (NDT) map-based localization method, the NDT map being generated by post-processing a point cloud for the predetermined region; and
calculating a third localization value for the vehicle using a third localization technology for performing localization according to a lane matching-based localization method, and
the determining of the position and orientation of the vehicle includes deriving position information of the vehicle and orientation information of the vehicle by fusing the calculated first localization value, the calculated second localization value, and the calculated third localization value.

5. The method for localizing an autonomous vehicle by fusing a plurality of localization technologies of claim 4, wherein the calculating of the third localization value includes
generating a lane precision map for the predetermined region;
generating real-time lane information using a real-time point cloud acquired from the vehicle; and
matching the generated lane precision map with the generated real-time lane information to calculate the third localization value for the vehicle.

6. The method for localizing an autonomous vehicle by fusing a plurality of localization technologies of claim 5, wherein the matching of the generated lane precision map with the generated real-time lane information to calculate the third localization value for the vehicle includes deriving the position information of the vehicle and the orientation information of the vehicle by matching information included in the generated lane precision map with information included in the generated real-time lane information based on a vehicle coordinate system with a point in the vehicle as an origin.

7. The method for localizing an autonomous vehicle by fusing a plurality of localization technologies of claim 5, wherein the generating of the lane precision map includes
extracting only points corresponding to a ground surface from the point cloud acquired by scanning the predetermined region to generate a ground surface point cloud for the predetermined region;
defining a range of interest (ROI) corresponding to the lane in the point cloud acquired by scanning the predetermined region to generate an ROI map for the predetermined region; and
extracting only points matched with points included in the generated ROI map and having an intensity equal to or greater than a threshold value from among a plurality of points included in the generated ground surface point cloud to generate the lane precision map for the predetermined region.

8. The method for localizing an autonomous vehicle by fusing a plurality of localization technologies of claim 7, wherein the generating of the ROI map includes
extracting a plurality of lane candidate points from the point cloud acquired by scanning the predetermined region based on a predefined range, the predefined range including a longitudinal range, a lateral range, a height range, and an intensity range;
connecting the plurality of extracted lane candidate points based on a gradient between the plurality of extracted lane candidate points;
setting a region having a predetermined size including the plurality of connected lane candidate points as a unit ROI; and
combining the plurality of unit ROIs set for the plurality of point clouds acquired from a plurality of different frames to generate the ROI map for the predetermined region.

9. The method for localizing an autonomous vehicle by fusing a plurality of localization technologies of claim 7, wherein the generating of the ROI map includes
labeling lanes on the point cloud acquired by scanning the predetermined region to define a road structure for the predetermined region, thereby generating a road network map for the predetermined region; and
setting an area having a predetermined size including lanes labeled on the generated road network map as the ROI to generate the ROI map for the predetermined region.

10. The method for localizing an autonomous vehicle by fusing a plurality of localization technologies of claim 5, wherein the generating of the lane precision map includes
extracting only points corresponding to a ground surface from the point cloud acquired by scanning the predetermined region to generate a ground surface point cloud for the predetermined region;
labeling lanes in the point cloud acquired by scanning the predetermined region to define a road structure for the predetermined region, thereby generating a road network map for the predetermined region; and
extracting only points located on the lane labeled on the generated road network map from among the plurality of points included in the generated ground surface point cloud to generate the lane precision map for the predetermined region.

11. The method for localizing an autonomous vehicle by fusing a plurality of localization technologies of claim 5, wherein the generating of the lane precision map includes:
extracting a plurality of points corresponding to the lane from the point cloud acquired by scanning the predetermined region;
approximating the plurality of extracted points into a line shape to acquire direction information of each of the plurality of extracted points; and
generating a lane precision map including position information of each of the plurality of extracted points and the direction information of each of the plurality of extracted points.

12. The method for localizing an autonomous vehicle by fusing a plurality of localization technologies of claim 5, wherein the generating of the real-time lane information includes
acquiring a point cloud collected in real time through a sensor included in the vehicle;
setting a range of interest (ROI) on the acquired point cloud;
extracting a plurality of points included in a predefined range from among the points included in the set ROI, the predefined range including a longitudinal range, a lateral range, a height range, and an intensity range; and
connecting the plurality of extracted points based on a gradient between the plurality of extracted points to generate the real-time lane information

13. The method for localizing an autonomous vehicle by fusing a plurality of localization technologies of claim 12, wherein the setting of the ROI includes setting the ROI in a three-dimensional space shape having a predetermined size in the acquired point cloud with reference to any one of a position of a center point of the vehicle and a position of the sensor included in the vehicle.

14. The method for localizing an autonomous vehicle by fusing a plurality of localization technologies of claim 12, wherein the setting of the ROI includes setting the ROI in the three-dimensional space shape having a predetermined size at a position corresponding to a direction in which the vehicle travels in the acquired point cloud with reference to the direction in which the vehicle travels.

15. The method for localizing an autonomous vehicle by fusing a plurality of localization technologies of claim 12, wherein the setting of the ROI includes
acquiring video data generated by filming a region in the direction in which the vehicle travels through a camera sensor included in the vehicle;
analyzing the acquired video data to identify a lane; and
determining a position relative to the identified lane with reference to the vehicle, determining a position at which the ROI is set based on the determined relative position, and setting the ROI in the three-dimensional space shape having the predetermined size at the determined position at which the ROI is set in the acquired point cloud.

16. The method for localizing an autonomous vehicle by fusing a plurality of localization technologies of claim 5, wherein
the generating of the real-time lane information includes
acquiring a point cloud collected in real time through a sensor included in the vehicle;
setting a range of interest (ROI) on the acquired point cloud;
defining a ground surface within the set ROI by approximating points included in the set ROI into a plane shape;
extracting a plurality of points included in a predefined range from among points located on the defined ground surface, the predefined range including a longitudinal range, a lateral range, a height range, and an intensity range; and
connecting the plurality of extracted points based on a gradient between the plurality of extracted points to generate the real-time lane information.

17. The method for localizing an autonomous vehicle by fusing a plurality of localization technologies of claim 5, wherein the generating of the real-time lane information includes acquiring the point cloud collected in real time through a sensor included in the vehicle;
setting a range of interest (ROI) in the acquired point cloud;
extracting a plurality of points included in a predefined range from among the points included in the set ROI, the predefined range including a longitudinal range, a lateral range, a height range, and an intensity range;
acquiring direction information of each of the plurality of extracted points by approximating the plurality of extracted points into a line shape; and
generating real-time lane information including t position information for each of the plurality of extracted points and the direction information of each of the plurality of extracted points.

18. A computing device that performs a method for localizing an autonomous vehicle by fusing a plurality of localization technologies, the computing device comprising:
a processor;
a network interface;
a memory; and
a computer program loaded into the memory and executed by the processor, wherein the computer program includes
instructions for calculating a plurality of localization values by performing localization for a vehicle located in a predetermined region using a plurality of localization technologies for performing localization according to different localization methods; and
instructions for determining a position and orientation of the vehicle by fusing the plurality of calculated localization values as a result of localizing the vehicle.

19. A computing device-readable recording medium, on which a computer program coupled to the computing device to perform a method for localizing an autonomous vehicle by fusing a plurality of localization technologies, the method comprising:
calculating a plurality of localization values by performing localization for a vehicle located in a predetermined region using a plurality of localization technologies for performing localization according to different localization methods; and
determining a position and orientation of the vehicle by fusing the plurality of calculated localization values as a result of localizing the vehicle.
